(19) United States
(12) Patent Application Publication
(10) Pub. No.: US 2006/0126956 A1
(43) Pub. Date: Jun. 15, 2006

(54) Method of coding and decoding image

(75) Inventors: Jin Soo Lee, Seoul (KR); Min Sub Kim, Seoul (KR); Byoung Su Kang, Seongnam-si (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/300,759

(22) Filed: Dec. 14, 2005

(30) Foreign Application Priority Data
Dec. 14, 2004 (KR) 10-2004-0105725

(51) Int. Cl. G06K 9/46

(52) U.S. Cl. 382/243

(57) ABSTRACT

A method of coding/decoding an image is provided. The coding method includes comparing a previous image and a current image of successive images to divide a background region from an object region including an object of the previous image and an object of the current image, coding the object region, and creating data indicating whether the above coding operation is intended for the entire image or the object region and adding the created data to coded data.

This application claims the benefit of the Korean Patent Application No. 10-2004-0105725, filed on Dec. 14, 2004, which is hereby incorporated by reference as if fully set forth herein.

### BACKGROUND OF THE INVENTION

1. Field of the Invention

The present invention relates to a method of coding and decoding an image.

2. Description of the Related Art

Various kinds of mobile terminals have been provided. Although the mobile terminals get miniaturized, the resolution of screen is increasing and the number of colors expressible per pixel is increasing. Also, high-quality displays tend to be mounted.

In the mobile terminals, user interface (UI) is developed toward three-dimensional image and animation UI, as well as simple image. Accordingly, there is an increasing demand for memory space for recording an image stored in the mobile terminal and displaying it for the user interface. Developments of a dedicated compression codec for picture of the UI are actively in progress. Particularly, for a menu picture-type UI, a simple image is being replaced by an animation of successive images.

Specifically, an image codec for UI picture requires a fast decoding speed. Most pictures of the UI have to be display immediately when the user presses buttons. Therefore, in decoding an image stored for UI, a delay time that the user feels has to be minimized. The image has to be decoded and displayed fast as the user cannot feel the delay time. In most cases, the decoding and display have to be completed within 100 ms. For most of the mobile phones, for example a portable phone, a low-performance central processing unit (CPU) such as an advanced RISC machine 7 (ARM7) and ARM9 controls the UI and thus it is difficult to use a codec such as JPEG having a large amount of computation.

Therefore, a BITMAP that is an original data is used in the UI picture. Since the BITMAP does not perform a compression operation, a large-capacity memory is required. A codec having a compression ratio ranging from ½ up to ⅕ with respect to an original data is used as a codec dedicated to a UI picture. This codec is an applied method of a dictionary-based codec such as Lempel Zip Welch (LZW). Although this codec has a very fast decoding speed, a compression ratio ranges from ½ up to ⅕ with respect to the original data. The most important requirement of the codec dedicated to the UI picture is a fast decoding speed as well as the compression ratio. Accordingly, even in the same compression algorithm, the technology development to enable the encoding and decoding process to be processed according to the CPU is required.

A following dictionary-based codec is used as an image codec that stores a compressed UI in the mobile terminal and decodes it. FIG. 1 illustrates a concept of a related art dictionary-based codec. The dictionary-based codec is a method of encoding a portion to be currently encoded by referring to a previously encoded portion. Referring to FIG. 1, a portion to be currently encoded is encoded by referring to N number of previously encoded data spaced apart from a position to be currently encoded by a predetermined distance D. If the matching number of the portion to be currently encoded and the previously encoded portion is less than a preset reference value, the current pixel value is encoded. If the matching number is greater than the reference value, the coding is performed while the distance D from the portion to be currently encoded to the position where the matching starts, and the matching number N are encoded.

In the dictionary-based codec, the codec related information includes an information as to whether the matching exists or not, a pixel value, the matching number N and distance D. The information related to the existence of the matching can be expressed in bit and have a header region. The pixel value is an information that can be expressed in byte and have a data region. The matching number N and the distance D are information requiring bit and byte.

The dictionary-based codec codes a still picture using one output buffer. One output buffer is designated during a coding process, and an encoding is performed while using a header pointer and a data pointer. That is, the header and the data are alternately stored in a bitstream structure. The method of alternately using the header and the data in one output buffer does not cause problems in PC-like environment. However, such a method causes problems in an environment with restricted memory and resource such as a mobile terminal.

That is, when the header and the data are repeatedly stored in one output buffer, positions of pointers where a next header and a next data are located have to be calculated each time. Also, it is necessary to access the memory based on one header and data. Consequently, the number of times of memory access increases and the decoding speed is degraded. Specifically, in the case of the ARM that is widely used as a processor in the mobile terminal, these factors will degrade the decoding and display speed of UI picture. Thus, there is a demand for a technology that has a fast decoding and display speed even when the dictionary-based codec is applied in a field requiring a fast decoding speed, such as a UI picture of a mobile terminal.

Meanwhile, when the UI picture of the mobile terminal is implemented using an animation, the amount of data that must be processed for the animation further increases. Particularly, when the ARM is used as a processor in the mobile terminal, the animation picture is difficult to rapidly display by a related art successive image coding/decoding scheme.

Therefore, there is required an improved technology for rapidly coding/decoding an animation of successive images by the dictionary-based coding scheme, which can reduce the required capacity of the memory by the system while satisfying the user's demand for the animation.

### SUMMARY OF THE INVENTION

Accordingly, the present invention is directed to a method of coding and decoding an image that substantially obviate one or more problems due to limitations and disadvantages of the related art.

An object of the present invention is to provide an image coding/decoding method capable of efficiently coding and rapidly decoding successive images.

Another object of the present invention is to provide an image coding/decoding method capable of efficiently coding and rapidly decoding successive images by a dictionary-based coding/decoding scheme.

A further another object of the present invention is to provide an image coding/decoding method capable of efficiently coding and rapidly decoding successive images for an animation in a UI picture of a mobile terminal by a dictionary-based coding/decoding scheme.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of coding an image, including: comparing a previous image and a current image of successive images to divide a background region from an object region including an object of the previous image and an object of the current image; coding the object region; and creating data indicating whether the above coding operation is intended for the entire image or the object region and adding the created data to coded data.

In another aspect of the present invention, there is provided a method of coding an image, including: coding the entire region of the first image of successive images; dividing a background region from an object region including an object of a previous image and an object of a current image with respect to a current image of the second or later frames; and coding the object region of the current image.

In a further another aspect of the present invention, there is provided a method of decoding coded image by dividing a background region from an object region including an object of a current image and an object of a previous image, the method including: decoding the entire first image; and decoding the object region of the second or later frame.

According to the present invention, the background region is not coded in the coding operation, and thus the compression rate can be enhanced. The present coding/decoding method can be performed on a UI animation such as a menu of a mobile terminal, thereby making it possible to rapidly display the corresponding picture and to reduce the required capacity of the memory. In addition, the present coding/decoding method can be applied to the coding/decoding operation not only for the UI-dedicated animation image but also for other types of animation images.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a concept of a related art dictionary-based codec;

FIG. 2 is a conceptual diagram illustrating a method of coding successive images according to an embodiment of the present invention;

FIG. 3 is a conceptual diagram illustrating a basic encoding algorithm for the coding method according to the present invention;

FIG. 4 is a flowchart illustrating a method of coding successive images according to an embodiment of the present invention;

FIG. 5 is a diagram illustrating an example where a flag is inserted during a coding operation on successive images;

FIG. 6 is a flowchart illustrating a method of decoding successive images according to an embodiment of the present invention; and

FIG. 7 is a conceptual diagram illustrating a process of decoding successive images encoded by the coding method according to the present invention.

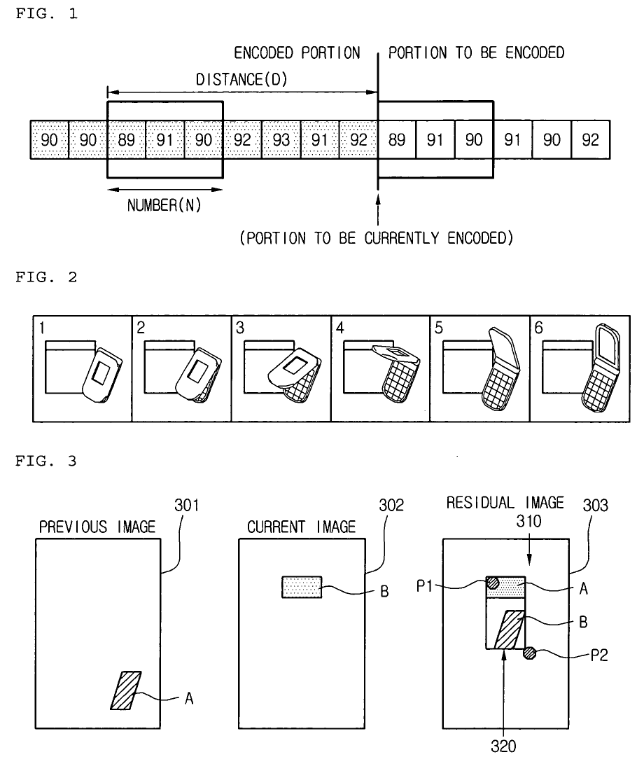

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

FIG. 2 is a conceptual diagram illustrating a method of coding successive images according to an embodiment of the present invention.

Referring to FIG. 2, a UI animation, such as a menu used in a mobile terminal, includes an arrangement of similar simple images. The main feature of the UI animation is that an animation effect is obtained by moving one or two object image on a background image. For example, as illustrated in FIG. 2, a mobile phone-shaped object image moves to create an animation formed of six images.

The present invention provides an image coding/decoding method capable of efficiently creating an animation effect by successively displaying similar images. In the present embodiment, similar successive images are divided into a background region and an object region and then the images are coded and decoded using a dictionary-based coding scheme.

FIG. 3 is a conceptual diagram illustrating a basic encoding algorithm for the coding method according to the present invention.

Referring to FIG. 3, a reference numeral 301 denotes a previous image that is previously encoded on a UI animation picture such as a menu used in a mobile terminal. A reference numeral 302 denotes a current image that is to be encoded on the animation picture. A reference numeral 303 denotes a residual image that is to be encoded by comparison of the previous image 301 and the current image 302.

The residual image 303 is an image region that is obtained by subtracting the previous image 301 from the current image 302. The residual image 303 is divided into a background region 310 and an object region 320. The object region 320 is a new region created by an object A of the previous image 301 and an object B of the current image 302. The background region 310 is a group of pixels represented by a value of ‘0’, and the object region 320 is a group of pixels represented by a non-0 value.

The related art method codes an image irrespective of the similarity between images.

In the present embodiment, only the object region 320 of the residual image 302 is coded by the UI-dedicated codec using the dictionary-based coding scheme, without coding the background region 310 of the residual image 303. In addition, data about a start point P1 and an end point P2 of the object region 320 are encoded as data indicating the object region 320. The data indicating the object region 320 are referred during the corresponding decoding process.

FIG. 4 is a flowchart illustrating a method of coding successive images according to an embodiment of the present invention.

Referring to FIG. 4, successive image data are inputted for coding in operation S410. In operation S420, it is determined whether or not the inputted image data is the first frame (image). If the inputted image data is the first frame, the method proceeds to operation S430, and if not, the method proceeds to operation S440. In operation S430, the entire image is coded using the dictionary-based coding scheme. In operation S440, the image is divided into the background region 310 and the object region 320 and then only the object region 320 is coded.

Operation S440 will now be described in detail. In operation S441, the inputted image data are divided into the background region 310 and the object region 320. For this purpose, the residual image 303 is obtained by subtracting the previous image 301 from the current image 302. The residual image 303 includes the object A of the previous image 301 and the object B of the current image 302. After the current image is divided into the object region 320 and the background region 310, only the object region 320 is coded by the dictionary-based coding scheme in operation S442.

Upon completion of the coding operation on the object region 320, data indicating the object region 320 among the entire residual image are added. In operation S443, for example, data about the start point P1 and the end point P2 of the object region 320 are encoded as data indicating the object region 320. Therefore, the object region 320 can be identified from the data indicating the object region 320. Accordingly, only the object region can be decoded during the corresponding image decoding process by referring to the data indicating the object region 320.

After the entire first frame (image) is coded or only the object region is coded with respect to the second or later frames, data indicating whether or not the coded data corresponds to the first frame are added in operation S450. In the present embodiment, a 1-bit flag may be used as the data indicating whether or not the coded data corresponds to the first frame.

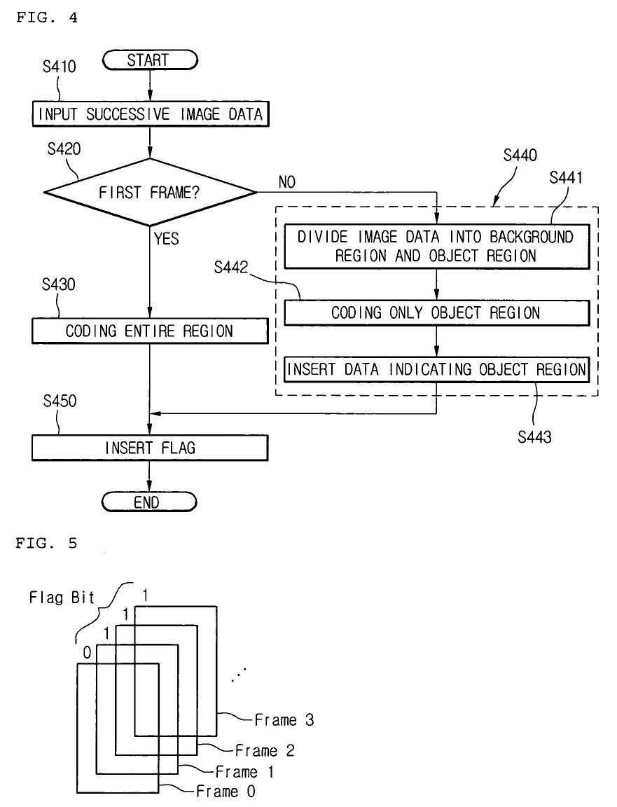

FIG. 5 is a diagram illustrating an example where a flag is inserted during a coding operation on successive images.

Referring to FIG. 5, when only the object region is coded during the coding operation on the successive images, ‘1’ is inserted as a flag. On the other hand, when the entire image region is coded, ‘0’ is inserted as a flag. Accordingly, whether the coding operation has been performed on only the object region or the entire image region can be determined during the corresponding decoding operation according to whether the flag is ‘1’ or ‘0’.

In case of the first image frame, the entire image region is compressed by the dictionary-based coding scheme, and the resulting data are encoded after insertion of a ‘0’ flag thereinto. In case of the second or later frames, the image frame is divided into a background region 310 and an object region 320, only the object region 320 is compressed, and the resulting data are encoded after insertion of a ‘1’ flag thereinto.

A method of decoding successive images according to the present invention will now be described in detail.

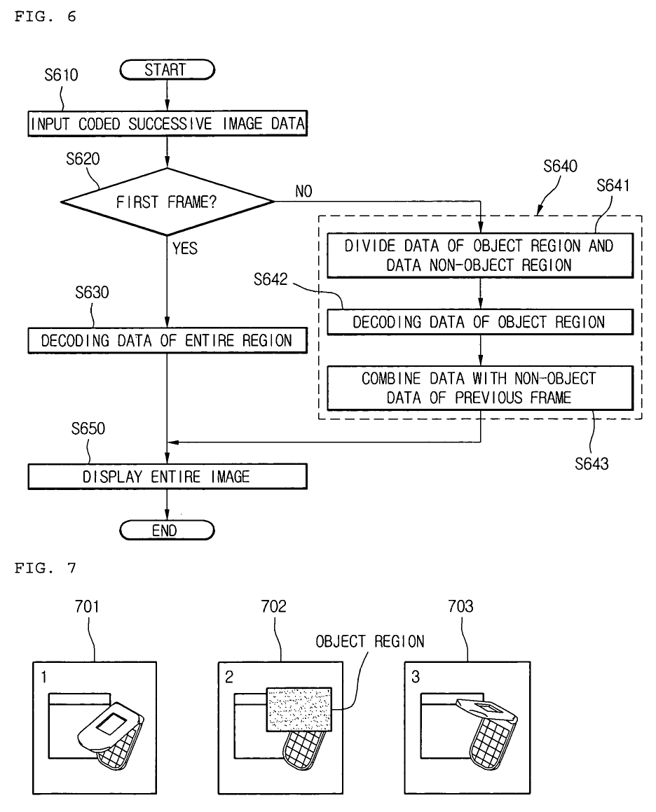

FIG. 6 is a flowchart illustrating a method of decoding successive images according to an embodiment of the present invention.

Referring to FIG. 6, coded successive images are inputted in operation S610. In operation S620, it is determined whether or not the inputted image data correspond to the first frame (image). Whether or not the inputted image data correspond to the first frame can be determined from the flag bit inserted during the coding operation. When the inserted flag bit is ‘0’, the first frame (image) needs to be currently decoded. On the other hand, when the inserted flag bit is ‘1’, the second or later frames (image) need to be currently decoded.

If the inputted image data correspond to the first frame, the entire region of the first frame image is decoded in operation S630. That is, when a read flag bit is ‘0’, it is determined that the entire region of the first frame image was coded in the previous coding operation. Therefore, the entire image region is decided using the UI-dedicated codec. For example, in case where the image data are coded using a dictionary-based coding scheme, the coded image data can be decoded using a dictionary-based decoding scheme.

On the other hand, if the inputted image data correspond to the second or later frames (not the first frame), only the object region of the frame is decoded in operation S640. That is, when a read flag bit is ‘1’, it is determined that only the object region was coded in the previous coding operation. Therefore, the data indicating the object region is read in to discriminate and decode the image data of the object region. At this time, the same background region as in the previous frame is used and an image formed of only the object region is decoded and combined with the background region.

Operation S640 will now be described in detail.

In operation S641, the inputted image data are divided into a background region and an object region. This division can be performed using the data indicating the object region, that is, a start point P1 and an end point P2 of the object region. Thereafter, the object region data are decoded in operation S642. In case where the object region was coded using the dictionary-based coding scheme, the coded object region is decoded using the dictionary-based decoding scheme. Thereafter, using the start point P1 and the end point P2, non-object data of the previous frame, that is, the background region, is combined with the object region in operation S643.

Thereafter, the entire image is displayed in operation S650. In operation S650, the decoded image data of the first frame and the decoded data of the second or later frames are successively displayed.

FIG. 7 is a conceptual diagram illustrating a process of decoding successive images encoded by the coding method according to the present invention.

Referring to FIG. 7, a reference numeral 701 denotes an image corresponding to when a flag bit is ‘0’. A reference numeral 702 denotes an object region corresponding to when a flag bit is ‘1’. When the flag bit is ‘0’, the entire image region is decoded. On the other hand, when the flag bit is ‘1’, the object region is decoded. At this time, the background image of the previous frame is stored in a decoding buffer, and only the object region is decoded and combined with the non-object region data of the previous frame, thereby obtaining a completely decoded image as denoted as a reference numeral 703.

As described above, the background region is not coded with respect to the second or later frames during the coding operation, and thus the compression rate can be enhanced. Also, only the object region is decoded with respect to the second and later frames, and thus the UI animation can be efficiently implemented.

It will be apparent to those skilled in the art that various modifications and variations can be made in the present invention. Thus, it is intended that the present invention covers the modifications and variations of this invention provided they come within the scope of the appended claims and their equivalent.

What is claimed is:

1. A method for coding an image, comprising:
comparing a previous image and a current image of successive images to divide a background region from an object region including an object of the previous image and an object of the current image;
coding the object region; and
creating data indicating whether the above coding operation is intended for the entire image or the object region and adding the created data to coded data.

2. A method for coding an image, comprising:
coding the entire region of the first image of successive images;
dividing a background region from an object region including an object of a previous image and an object of a current image with respect to a current image of the second or later frames; and
coding the object region of the current image.

3. The method according to claim 2, wherein the coding operations are dictionary-based coding operations.

4. The method according to claim 2, further comprising data indicating whether the coding operation is intended for the entire region of the image or only the object region of the image.

5. The method according to claim 2, where a 1-bit flag is used as data indicating whether the coding operation is intended for the entire region of the image or only the object region of the image.

6. The method according to claim 2, further comprising data indicating the object region.

7. The method according to claim 2, further comprising data indicating a start point and an end point of the object region.

8. The method according to claim 2, wherein the object region is obtained by subtracting the previous image from the current image.

9. A method for decoding coded image by dividing a background region from an object region including an object of a current image and an object of a previous image, the method comprising:
decoding the entire first frame image; and
decoding the object region of the second or later frame image.

10. The method according to claim 9, wherein the image decoding operation are dictionary-base decoding operations.

11. The method according to claim 9, further comprising data indicating whether the decoding operation is intended for the entire region of the image or only the object region of the image.

12. The method according to claim 9, where a 1-bit flag is used as data indicating whether the decoding operation is intended for the entire region of the image or only the object region of the image.

13. The method according to claim 9, further comprising data indicating the object region.

14. The method according to claim 9, further comprising data indicating a start point and an end point of the object region.

15. The method according to claim 9, wherein the object region is obtained by subtracting the previous image from the current image.

16. The method according to claim 9, further comprising combining the decoded object region with a previously-decoded background region.
